(19) United States
(12) Patent Application Publication
(10) Pub. No.: US 2006/0245696 A1
(43) Pub. Date: Nov. 2, 2006

(54) Optical module and optical transmitter/receiver device

(75) Inventors: Yoshiyasu Sato, Yokohama-shi (JP); Hitomaro Tougu, Yokohama-shi (JP); Hiroaki Asano, Yokohama-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/547,970

(22) PCT Filed: Mar. 5, 2004
(86) PCT No.: PCT/JP04/02870

§ 371 Date: May 3, 2006

(30) Foreign Application Priority Data
Mar. 6, 2003 (JP) 2003-060592

(51) Int. Cl. G02B 6/36

(52) U.S. Cl. 385/88

(57) ABSTRACT

A technique to improve degree of freedom in mounting an electrode of an optical device on a wiring substrate without being affected by an angle in the optical fiber circumferential direction of the optical device provided for an optical module is disclosed. According to the technique, an optical device 5, from which a plurality of electrodes 61 to 64 protrude; and a wiring substrate 7, in which a plurality of electrical wirings 10 to connect to the respective plurality of electrodes are formed approximately concentrically are included. Respective ends of the electrodes are connected to the respective plurality of electrical wirings so that distances between the respective ends of the plurality of electrodes and the center of the optical device are different from each other.

### TECHNICAL FIELD

The present invention relates to an optical module in the optical communication field, and an optical transmitter-receiver using the optical module for optical transmitting and receiving.

### BACKGROUND ART

In this kind of optical module, in order to prevent transmitted light from being reflected by the end face of the optical fiber and returned to the light emitting device, which causes unstable oscillation of the light emitting device, the end face of the optical fiber is diagonally polished. Further, in general, when the polished face of the optical fiber is rotated in the circumferential direction, it is necessary to adjust the angle in the circumferential direction of the light emitting device to the most suitable angle in order to obtain necessary coupling efficiency, since coupling efficiency with the light emitting device is changed according to the rotation angle.

However, in the foregoing conventional example, when the angle in the optical fiber circumferential direction of the light emitting device varies according to every module, the degree of freedom of mounting when the electrode of the light emitting device is connected to the wiring substrate is very low. Therefore, there is a problem that precision, man hours, and cost of equipment in mounting become large.

Here, FIG. 19 and FIG. 20 show other conventional example described in the following Patent document 1. An optical device 21 such as an LD is mounted on a substrate 20. On the substrate 20, an electrical wiring 22, a light guide 23, a V groove 24, and a marker 25 are formed. The marker 25 is aligned with a marker 26 of the optical device 21. An unshown optical fiber is pushed onto the end of the V groove 24, and fixed thereto without aligning. Then, the optical device 21 is aligned with the optical fiber by the markers 25 and 26. However, in such a mounting method and such a structure, device mounting is not able to be corresponded to misalignment in the rotational direction in the plane face, on which an electrode is formed.

Patent document 1: Japanese unexamined patent application publication No. H08-334655 (FIG. 6 and paragraphs 0007 to 0010)

### DISCLOSURE OF THE INVENTION

In order to solve the problems of the foregoing conventional examples, it is an object of the present invention to provide an optical module capable of improving the degree of freedom in mounting the electrode of the optical device on the wiring substrate without being affected by the angle in the optical fiber circumferential direction of the optical device, and an optical transmitter-receiver using such an optical module for optical transmitting and receiving.

In order to attain the foregoing object, according to the invention of claim 1, an optical module includes:

an optical device, from which a plurality of electrodes protrude; and

a wiring substrate, in which a plurality of electrical wirings to be connected to the respective plurality of electrodes are formed approximately concentrically. Respective ends of the plurality of electrodes are connected to the respective plurality of electrical wirings so that distances between the respective ends of the plurality of electrodes and the center of the optical device are different from each other.

By this construction, electrical conduction becomes enabled regardless of the relative angle between the electrodes of the optical device and the electrical wirings. Therefore, mounting precision demanded in mounting the electrodes of the optical device and the substrate can be lowered. Consequently, improvement of process yield, improvement of productivity, and reduction of cost of equipment become enabled.

According to the invention of claim 2, in the optical module according to claim 1, one of the plurality of electrical wirings is formed approximately in the center of the approximate concentric circle.

By this construction, electrical conduction becomes enabled regardless of the relative angle between the electrodes of the optical device and the electrical wirings. Therefore, mounting precision demanded in mounting the electrodes of the optical device and the wiring substrate can be lowered. Consequently, improvement of process yield, improvement of productivity, and reduction of cost of equipment become enabled.

According to the invention of claim 3, in the optical module according to claim 1, the respective ends of the plurality of electrodes are respectively connected to the respective plurality of electrical wirings so that the respective ends of the plurality of electrodes are linearly aligned.

By this construction, electrical conduction becomes enabled regardless of the relative angle between the electrodes of the optical device and the electrical wirings. Therefore, mounting precision demanded in mounting the electrodes of the optical device and the wiring substrate can be lowered. Consequently, improvement of process yield, improvement of productivity, and reduction of cost of equipment become enabled. Further, since the shape of the electrode is not bent intricately, mounting becomes easy.

According to the invention of claim 4, in the optical module according to any one of claims 1 to 3, the respective plurality of electrical wirings have a through-bore formed longitudinally in the circumferential direction to connect the respective ends of the plurality of electrodes.

By this construction, electrical joint between the electrodes and the substrate becomes easy. Further, improvement of process yield and improvement of productivity become enabled.

According to the invention of claim 5, in the optical module according to any one of claims 1 to 3, the respective plurality of electrical wirings have a plurality of through-holes formed along the circumferential direction in order to insert the respective ends of the plurality of electrodes into one of the through-holes for every electrical wiring and solder the respective ends of the plurality of electrodes.

By this construction, electrical joint between the electrodes and the substrate becomes easy. Further, improvement of process yield and improvement of productivity become enabled.

According to the invention of claim 6, in the optical module according to any one of claims 1 to 3, the wiring substrate is formed in a state of steps for the respective plurality of electrical wirings, and the electrical wirings to connect the respective ends of the plurality of electrodes are formed on side faces of the steps.

By this construction, conduction with the wiring substrate becomes enabled even if individual lengths of the electrodes are different from each other. Further, joint itself becomes easy. Furthermore, improvement of process yield and improvement of productivity become enabled.

According to the invention of claim 7, in the optical module according to any one of claims 1 to 3, the wiring substrate is composed of a plurality of layers connected through through-holes.

By this construction, diversification and multifunction of the pattern of the wirings arranged on the substrate can be realized.

According to the invention of claim 8, in the optical module according to any one of claims 1 to 3, the respective plurality of electrical wirings have wirings doubly formed in the radial direction to connect the respective ends of the plurality of electrodes.

By this construction, it becomes enough to form the wirings only on a single face of the substrate. Therefore, it becomes possible to form an electrical wiring at low cost.

According to the invention of claim 9, the optical module according to any one of claims 1 to 3 has:

an insulating layer provided on the surface of the wiring substrate;

a plurality of electrical wirings formed on the rear face of the wiring substrate; and

a through-bore formed longitudinally in the circumferential direction or one or more through-holes in the insulating layer and the wiring substrate correspondingly to the electrical wirings. The respective ends of the plurality of electrodes are connected to the electrical wirings through the thorough-bore or the through-hole so that the insulating layer is sandwiched between an electrode protruding face of the optical device and the wiring substrate.

By this construction, the length of the electrode can be shortened. Further, the whole length from the optical device to the substrate after fixing by solder can be controlled by thicknesses of the wiring substrate and the nonconductive plate. Therefore, the optical module can be downsized, and process control becomes facilitated.

The invention of claim 10 is an optical transmitter-receiver using the optical module according to any one of claims 1 to 9 for optical transmitting and receiving.

By this construction, the optical transmitter-receiver having advantages shown in the foregoing respective claims can be provided.

### BRIEF DESCRIPTION OF THE DRAWINGS

FIG. 1 is a schematic construction view showing a first embodiment of an optical module according to the present invention;

FIG. 2 is a lateral cross section showing an outline of an integral structure including an optical device shown in FIG. 1;

FIG. 3A is a bottom plan view of the optical module of FIG. 1, and an explanation drawing showing a state that the optical device is not rotated in relation to a mother substrate;

FIG. 3B is a bottom plan view of the optical module of FIG. 1, and an explanation drawing showing a state that the optical device is rotated counterclockwise in relation to the mother substrate;

FIG. 3C is a bottom plan view of the optical module of FIG. 1, and an explanation drawing showing a state that the optical device is rotated clockwise in relation to the mother substrate;

FIG. 4 is a bottom plan view of the optical module of FIG. 1, and an explanation drawing showing a state that electrodes are connected to wirings;

FIG. 5A is an explanation drawing showing a first example of connection positions of the electrodes on the bottom face of the optical module of FIG. 1;

FIG. 5B is an explanation drawing showing a second example of connection positions of the electrodes on the bottom face of the optical module of FIG. 1;

FIG. 5C is an explanation drawing showing a third example of connection positions of the electrodes on the bottom face of the optical module of FIG. 1;

FIG. 5D is an explanation drawing showing a fourth example of connection positions of the electrodes on the bottom face of the optical module of FIG. 1;

FIG. 6 is an explanation drawing showing a second example of the wirings on the bottom face of the optical module of FIG. 1;

FIG. 7 is an explanation drawing showing a third example of the wirings on the bottom face of the optical module of FIG. 1;

FIG. 8 is an explanation drawing showing a second embodiment of the present invention;

FIG. 9 is an explanation drawing showing a third embodiment of the present invention;

FIG. 10 is an explanation drawing showing a fourth embodiment of the present invention;

FIG. 11 is a construction view showing a fifth embodiment of the present invention;

FIG. 12 is a construction view showing a sixth embodiment of the present invention;

FIG. 13 is a construction view showing a seventh embodiment of the present invention;

FIG. 14 is a construction view showing an eighth embodiment of the present invention;

FIG. 15 is a construction view showing a ninth embodiment of the present invention;

FIG. 16 is a side view showing the ninth embodiment of the present invention;

FIG. 17 is a construction view showing a tenth embodiment of the present invention;

FIG. 18 is a side view showing the tenth embodiment of the present invention;

FIG. 19 shows a construction view showing a conventional example; and

FIG. 20 is an explanation drawing showing a relation between markers as an alignment mark of FIG. 19.

### BEST MODE FOR CARRYING OUT THE INVENTION

Descriptions will be hereinafter given of embodiments of the present invention with reference to the drawings.

### First Embodiment

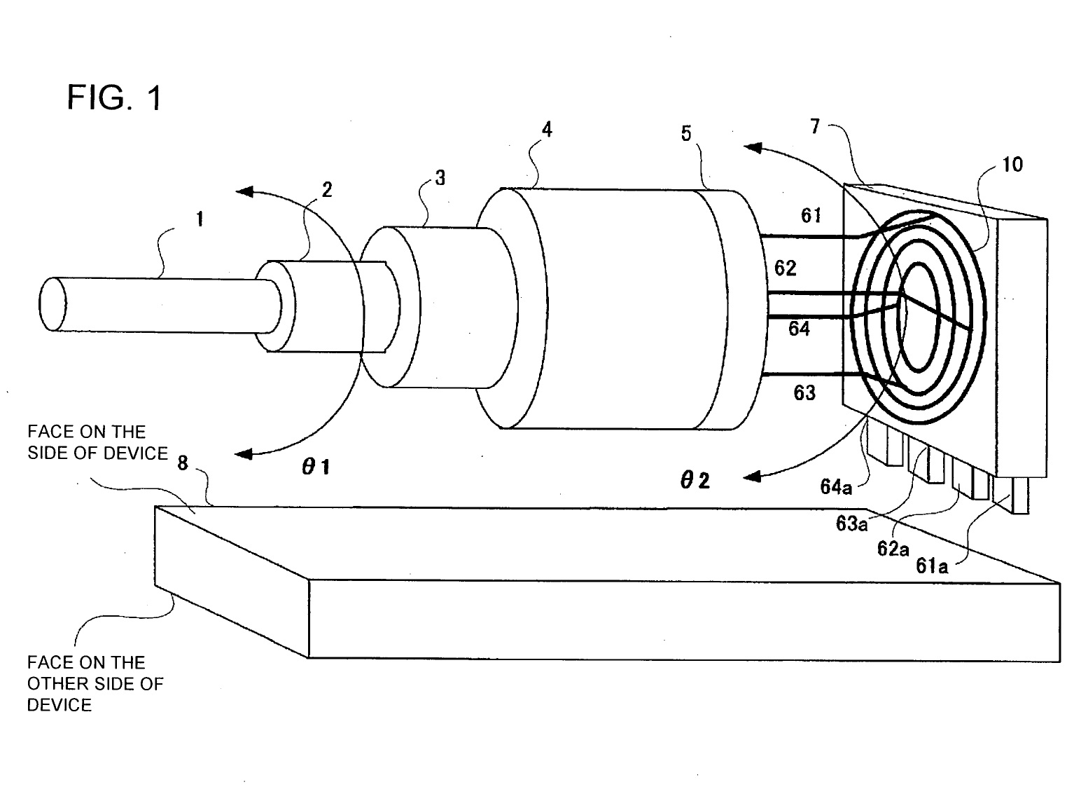

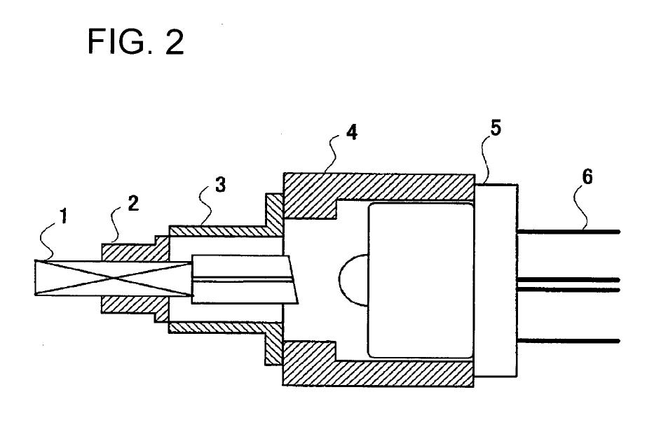

FIG. 1 is a schematic construction view showing a first embodiment of an optical module according to the present invention. “Optical module” in the present invention includes an optical transmitter module, an optical receiver module, and an optical transmitter and receiver module, which perform optical transmitting and/or optical receiving. FIG. 2 shows an outline of an integral structure including an optical device 5 shown in FIG. 1. The optical module is composed of an optical fiber 1 with a metal part 2 (ferrule), a metal part 3 (sleeve), a metal part 4 (flange), and an optical device 5 of an LD or a PD. A plurality of electrodes 6 (61, 62, 63, and 64) of the optical device 5 are respectively connected to a plurality of electrical wirings (also simply referred to wiring) 10 concentrically formed on a wiring substrate 7 such as a glass epoxy substrate, a flexible substrate, an electrical connector, and a semiconductor substrate. The plurality of wirings 10 on the wiring substrate 7 are respectively connected to electrodes 61a, 62a, 63a, and 64a. The electrodes 61a, 62a, 63a, and 64a are connected to a mother substrate 8.

The end of the optical fiber 1 is polished or cut at an diagonal angle of about 8 degrees. In general, when the polished face of the optical fiber 1 is rotated at an angle of θ1 in the circumferential direction, the coupling efficiency with the optical device 5 is changed by the angle θ1. Therefore, in order to obtain necessary coupling efficiency, it is necessary to optimally adjust the angle θ1. In FIG. 1, the optical fiber 1 can rotate at an angle of θ1 in the circumferential direction, and the optical device 5 can rotate at an angle of θ2 in the circumferential direction. After the relative angle θ1-θ2 made by the optical fiber 1 and the optical device 5 in the circumferential direction is adjusted, the foregoing parts 1 to 5 are jointed and integrated by using a method such as resistance welding, YAG welding, press fitting, and solder welding.

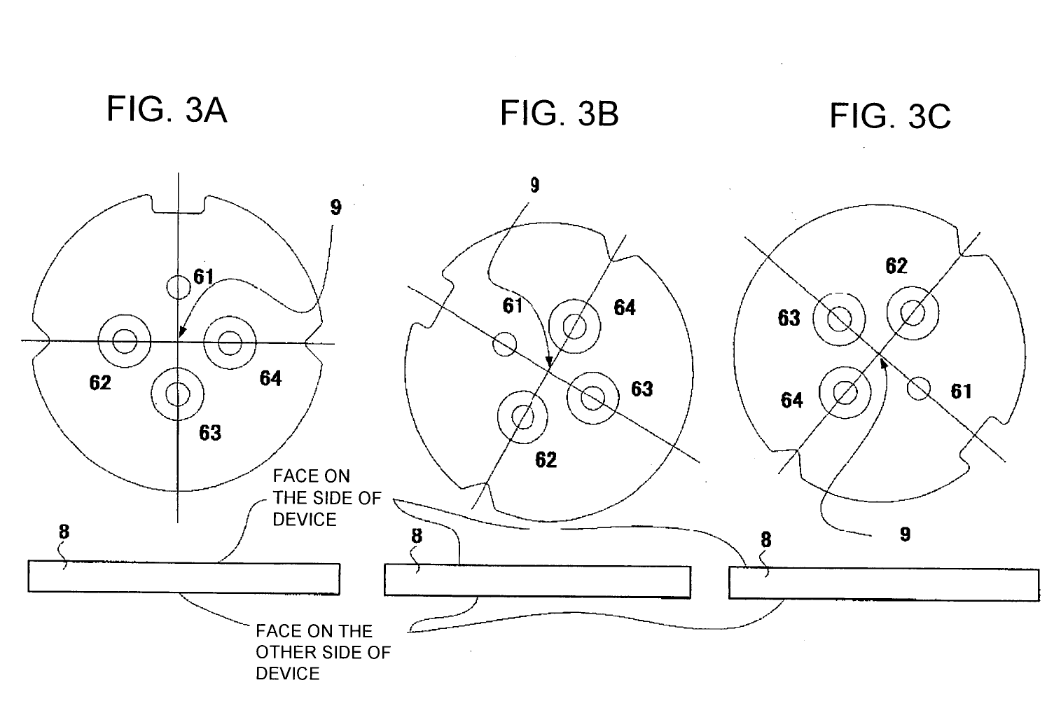

Here, the electrodes 6 of the optical device 5 are placed in a given position in the circumferential direction. FIG. 3A shows an arrangement of the optical device 5 and the electrodes 6 (61, 62, 63, and 64) when FIG. 1 is viewed from the bottom face. The respective electrodes 6 are equally spaced at 90 degrees in the circumferential direction in the same radial position in relation to a center point 9. According to the value of the foregoing θ, this arrangement is changed to the position relation that the respective electrodes 6 are rotated counterclockwise as shown in FIG. 3B, or changed to the position relation that the respective electrodes 6 are rotated clockwise as shown in FIG. 3C in relation to the mother substrate 8. Here, the case that the number of the electrode 6 is 4 is shown. However, the present invention can be applied to other cases with different number of the electrodes 6.

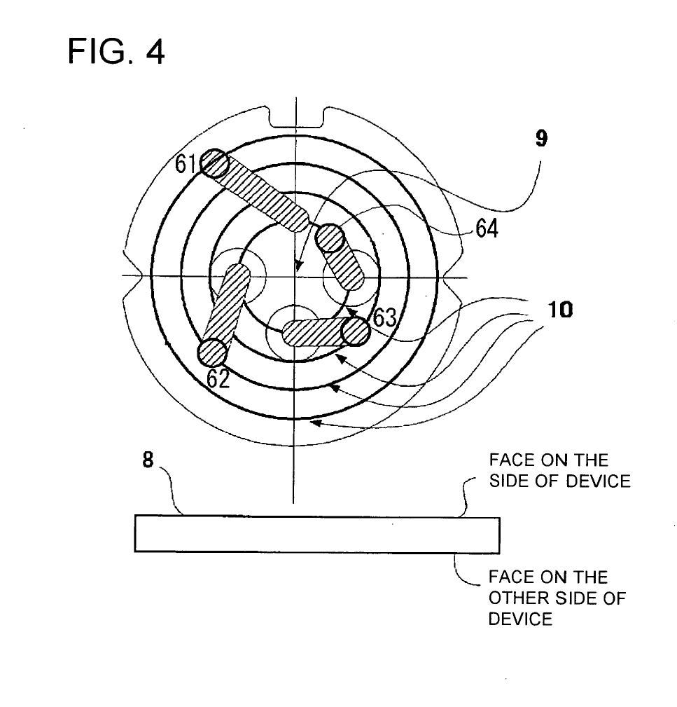

The ends of the electrodes 6 in the position relation of FIG. 3A are bent or the like to obtain a state shown in FIG. 4, and the shape of the wirings 10 formed on the wiring substrate 7 is formed, for example, concentrically as shown in FIG. 1. Thereby, whatever the position relation between the mother substrate 8 and the electrodes 6 of the optical device 5 is, electrical coupling can be easily obtained.

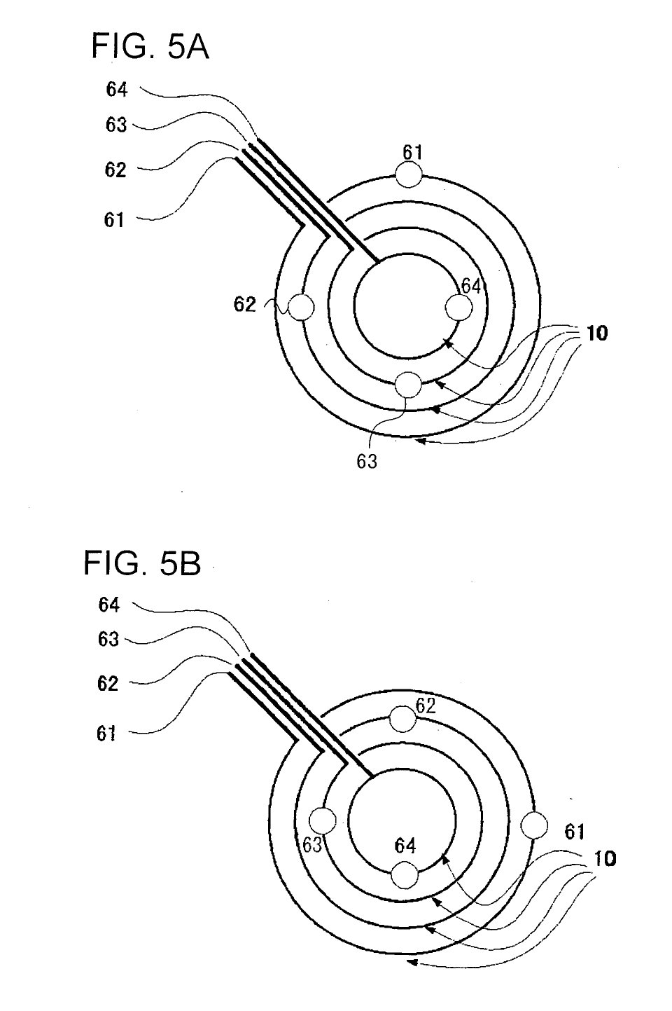

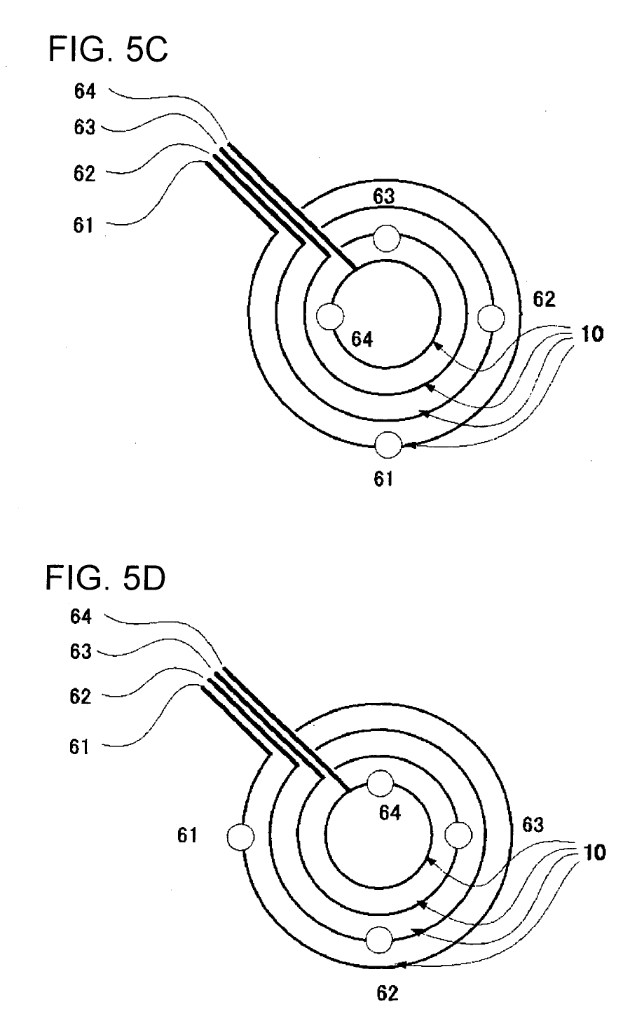

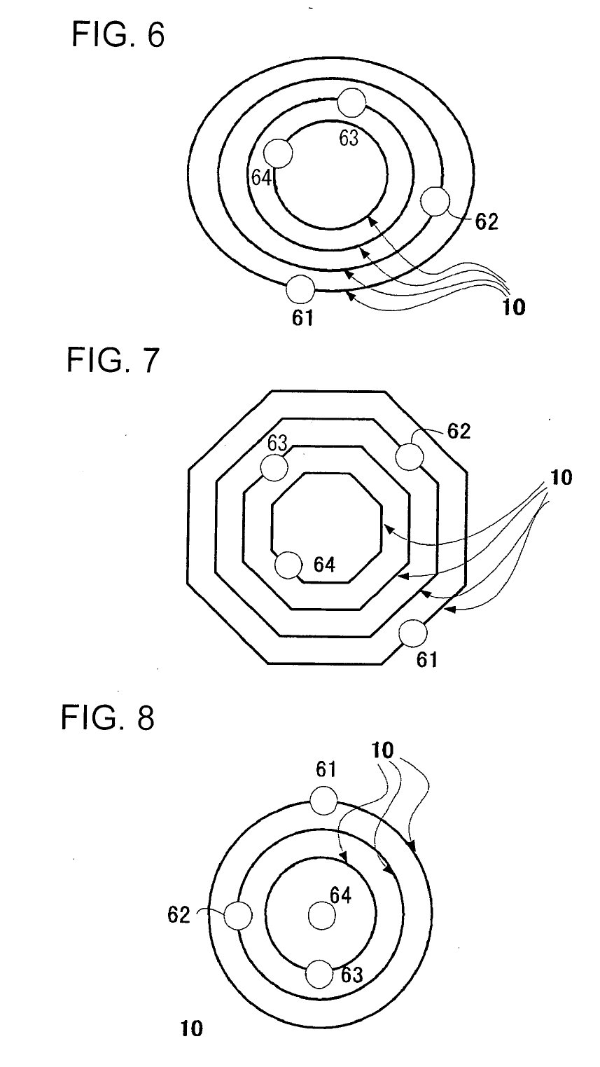

FIGS. 5A to 5D show that when the optical device 5 is rotated on the center point 9, electrical coupling between the respective electrodes 6 and the wirings 10 can be realized. As a pattern of the wirings 10 on the wiring substrate 7, instead of the concentric circle, the concentric oval shape as shown in FIG. 6 and the concentric polygon shape as shown in FIG. 7 may be adopted.

### Second Embodiment

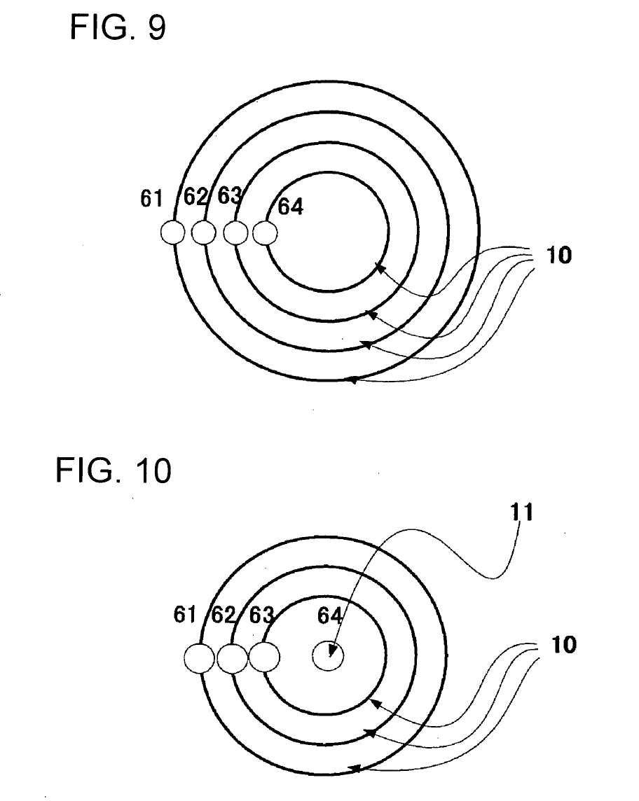

In a second embodiment, as shown in FIG. 8, the electrode 64, one of the plurality of electrodes 6 is connected to the wiring 10 in the center of the wiring substrate 7. By this construction, electrical conduction is enabled regardless of the relative angle between the electrodes 6 and the electrical wirings 10. Therefore, mounting precision demanded in mounting the electrodes 6 and the wiring substrate 7 can be lowered. Consequently, improvement of process yield, improvement of productivity, and reduction of cost of equipment become enabled.

### Third and Fourth Embodiments

In a third embodiment, as shown in FIG. 9, respective ends of the plurality of electrodes 61 to 64 are connected to the respective plurality of electrical wirings 10 so that the respective ends of the plurality of electrodes 61 to 64 are linearly aligned. Further, in a fourth embodiment, as shown in FIG. 10, respective ends of the plurality of electrodes 61 to 64 are linearly aligned, and the electrode 64 is connected to the wiring 10 in the center of the wiring substrate 7. By these constructions, electrical conduction becomes enabled regardless of the relative angle between the electrodes 6 and the electrical wirings 10. Therefore, mounting precision demanded in mounting the electrodes 6 and the wiring substrate 7 can be lowered. Consequently, improvement of process yield, improvement of productivity, and reduction of cost of equipment become enabled. Further, since the shape of the electrode 6 is not bent intricately, mounting becomes easy.

### Fifth Embodiment

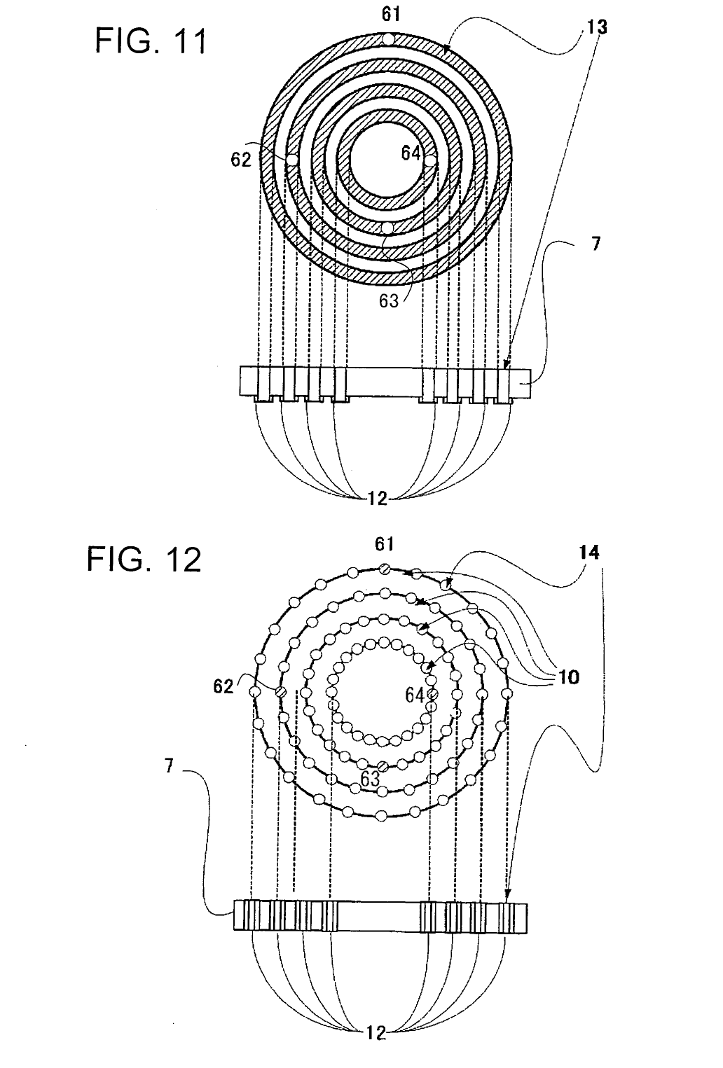

In the fifth embodiment, as shown in FIG. 11, a through-bore 13 is formed longitudinally in the circumferential direction for the respective plurality of electrical wirings 10. Respective ends of the plurality of electrodes 6 are connected to the respective through-bores 13. By this construction, electrical joint between the electrodes 6 and the wiring substrate 7 having a connection section 12 becomes easy. Further, improvement of process yield and improvement of productivity become enabled.

### Sixth Embodiment

In a sixth embodiment, as shown in FIG. 12, a plurality of through-holes 14 (and the connection section 12) are formed along the circumferential direction for the respective plurality of electrical wirings 10. Respective ends of the plurality of electrodes 6 are inserted into one of the plurality of through-holes 14 for every electrical wiring 10, and soldered at the connection section 12 on the rear face of the wiring substrate 7. By this construction, electrical joint between the electrode or a pin and the substrate becomes easy. Further, improvement of process yield and improvement of productivity become enabled.

### Seventh Embodiment

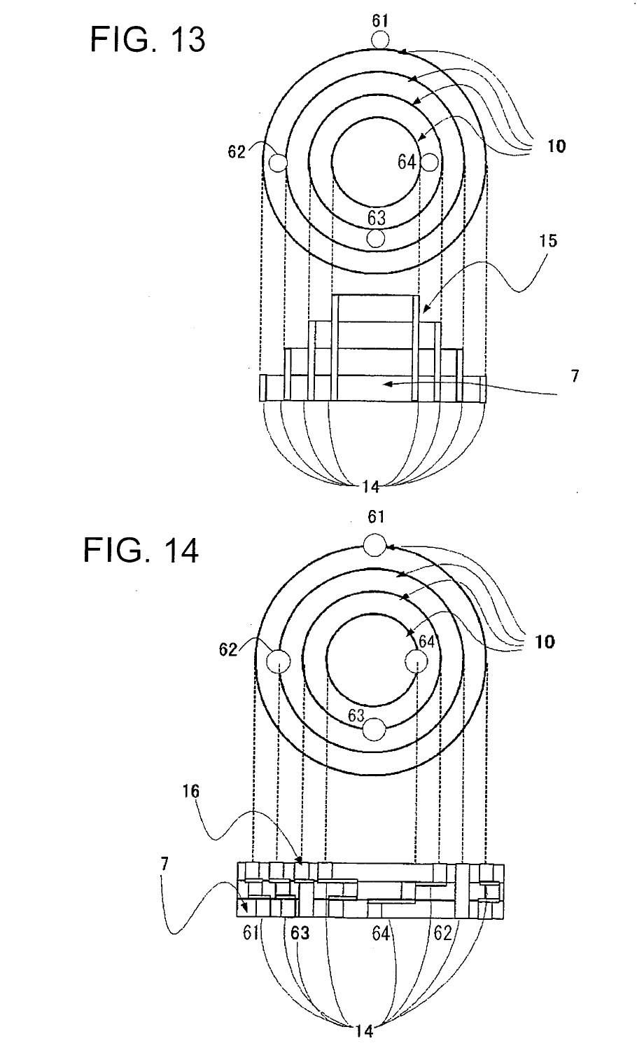

In a seventh embodiment, as shown in FIG. 13, the wiring substrate 7 is formed in a state of steps for the respective plurality of electrical wirings 10, the respective electrical wirings 10 are formed on the side face of a step section 15, and respective ends of the plurality of electrodes 6 are connected to the respective electrical wirings 10 formed on the side face. Further, the wiring substrate 7 is connected to the lowest layer through the through-holes 14. By this construction, conduction with the wiring substrate 7 becomes enabled even if individual lengths of the electrodes 6 are different from each other. Further, joint itself becomes easy. Furthermore, improvement of process yield and improvement of productivity become enabled.

### Eighth Embodiment

In an eighth embodiment, as shown in FIG. 14, the wiring substrate 7 is composed of a plurality of layers. The respective layers are connected though the through-hole 14 and a through-hole 16. By this construction, diversification and multifunction of the pattern of the wirings 10 arranged on the wiring substrate 7 can be realized.

### Ninth Embodiment

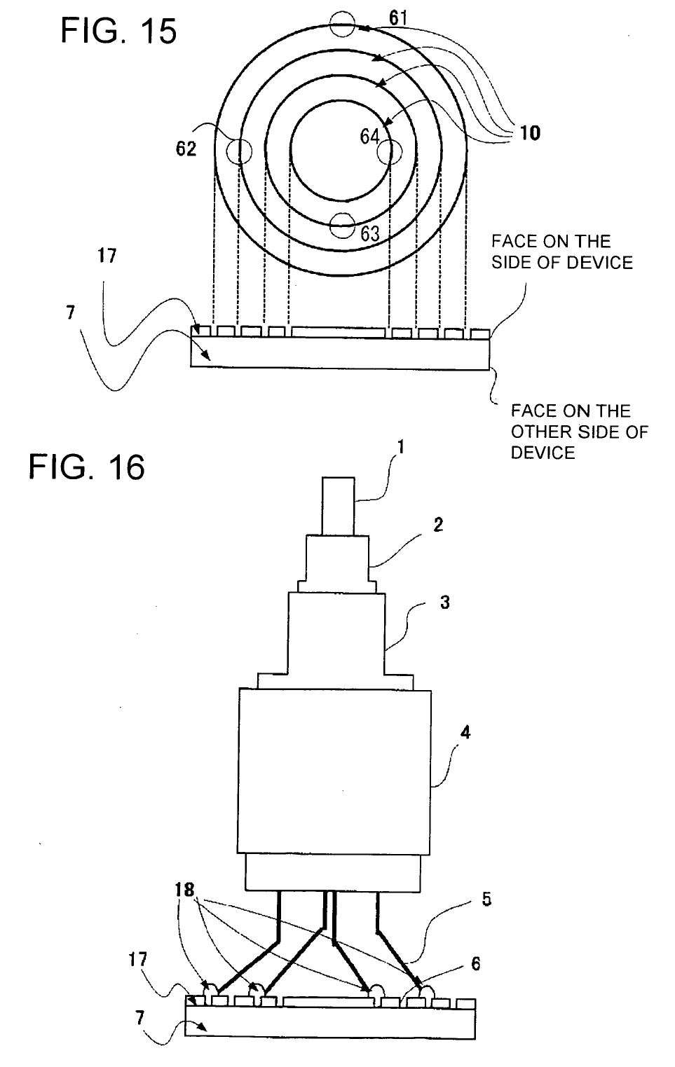

In a ninth embodiment, as shown in FIG. 15 and FIG. 16, the respective plurality of electrical wirings 10 are formed from double wirings in the radial direction. Respective ends of the plurality of electrodes 6 are connected to the gap between the double wirings by a solder 18. On a surface 17 of the wirings 10, a nonconductive film is not formed. By this construction, it becomes enough to form the wirings 10 only on a single face of the wiring substrate 7. Therefore, it becomes possible to form an electrical wiring at low cost.

### Tenth Embodiment

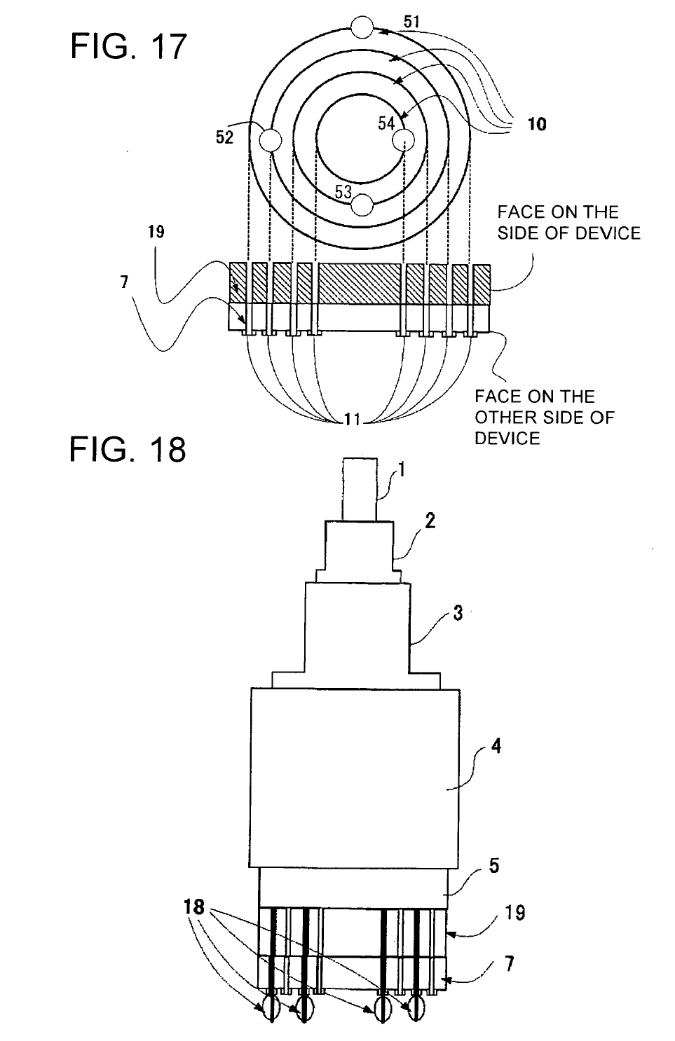

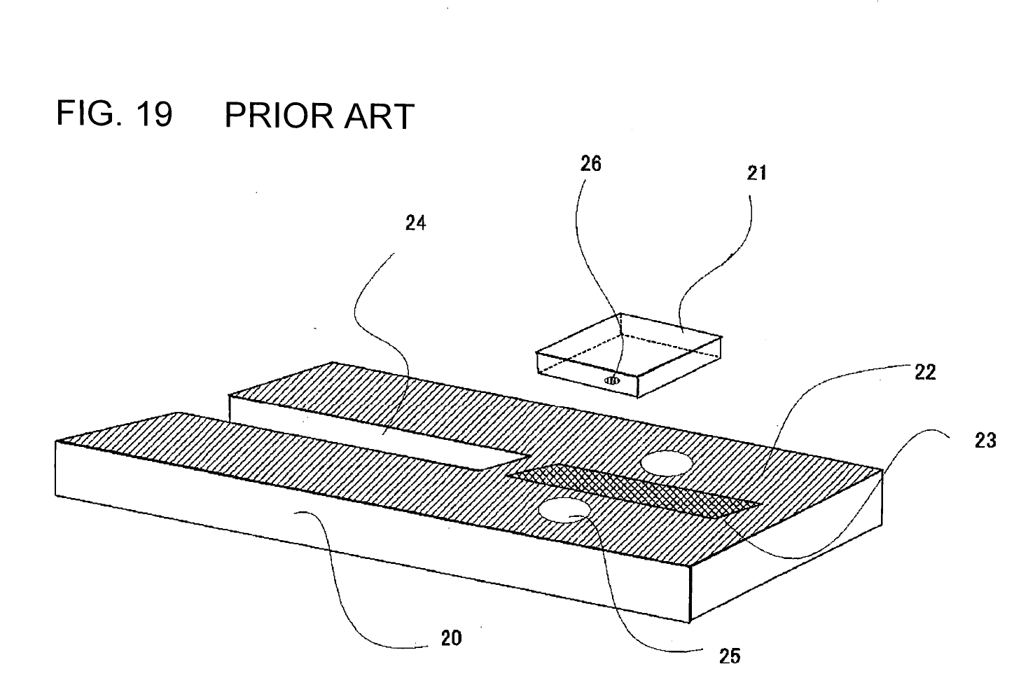

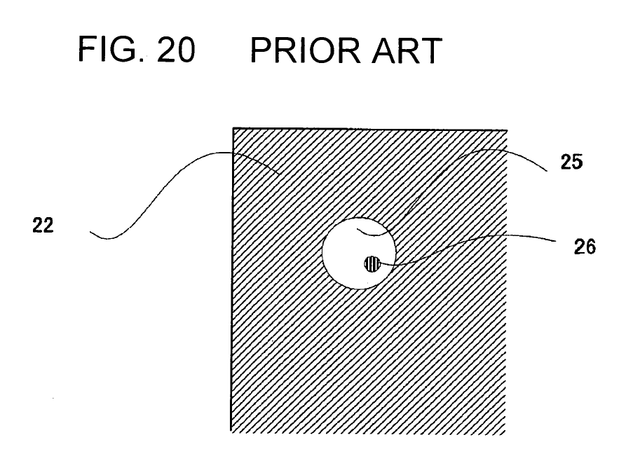

In a tenth embodiment, as shown in FIG. 17 and FIG. 18, a nonconductive plate 19 is provided on the surface of the wiring substrate 7, and the plurality of electrical wirings 10 are formed on the rear face of the wiring substrate 7. Further, in the nonconductive plate 19 and the wiring substrate 7, a through-bore longitudinal in the circumferential direction or one or more through-holes 11 are formed correspondingly to the electrical wirings 10. Respective ends of the plurality of electrodes 6 are connected to the electrical wirings 10 through the through-bore or the through-hole 11 by the solder 18 so that the nonconductive plate 19 is sandwiched between the electrode protruding face of the optical device 5 and the wiring substrate 7. By this construction, the length of the electrode 6 can be shortened. Further, the whole length from the optical device 5 to the wiring substrate 7 after fixing by solder can be controlled by thicknesses of the wiring substrate 7 and the nonconductive plate 19. Therefore, the optical module apparatus can be downsized, and process control becomes facilitated.

### INDUSTRIAL APPLICABILITY

As described above, according to the inventions of claims 1 and 2, electrical conduction becomes enabled regardless of the relative angle between the electrodes of the optical device and the electrical wirings. Therefore, mounting precision demanded in mounting the electrodes of the optical device and the substrate can be lowered. Consequently, improvement of process yield, improvement of productivity, and reduction of cost of equipment become enabled.

According to the invention of claim 3, electrical conduction becomes enabled regardless of the relative angle between the electrodes of the optical device and the electrical wirings. Therefore, mounting precision demanded in mounting the electrodes of the optical device and the wiring substrate can be lowered. Consequently, improvement of process yield, improvement of productivity, and reduction of cost of equipment become enabled. Further, since the shape of the electrode is not bent intricately, mounting becomes easy.

According to the invention of claim 4, electrical joint between the electrodes and the substrate becomes easy. Further, improvement of process yield and improvement of productivity become enabled.

According to the invention of claim 5, electrical joint between the electrodes and the substrate becomes easy. Further, improvement of process yield and improvement of productivity become enabled.

According to the invention of claim 6, conduction with the wiring substrate becomes enabled even if individual lengths of the electrodes are different from each other. Further, joint itself becomes easy. Furthermore, improvement of process yield and improvement of productivity become enabled.

According to the invention of claim 7, diversification and multifunction of the pattern of the wirings arranged on the substrate can be realized.

According to the invention of claim 8, it becomes enough to form the wirings only on a single face of the substrate. Therefore, it becomes possible to form an electrical wiring at low cost.

According to the invention of claim 9, the length of the electrode can be shortened. Further, the whole length from the optical device to the substrate after fixing by solder can be controlled by thicknesses of the wiring substrate and the nonconductive plate. Therefore, the optical module can be downsized, and process control becomes facilitated.

According to the invention of claim 10, an optical transmitter-receiver having advantages shown in claims 1 to 9 can be provided.

1. An optical module comprising:
an optical device, from which a plurality of electrodes protrude; and
a wiring substrate, in which a plurality of electrical wirings to be connected to the respective plurality of electrodes are formed in the shape of approximate concentric circles with different radii, wherein respective ends of the plurality of electrodes are connected to the respective plurality of electrical wirings.

2. The optical module according to claim 1, wherein one of the plurality of electrical wirings is formed approximately in the center of the approximate concentric circle.

3. The optical module according to claim 1, wherein the respective ends of the plurality of electrodes are respectively connected to the respective plurality of electrical wirings so that the respective ends of the plurality of electrodes are linearly aligned.

4. (canceled)

5. The optical module according to claim 1, wherein the respective plurality of electrical wirings have a plurality of through-holes formed along the circumferential direction in order to insert the respective ends of the plurality of electrodes into one of the through-holes for every electrical wiring and solder the respective ends of the plurality of electrodes.

6. The optical module according to claim 1, wherein the wiring substrate is formed in a state of steps for the respective plurality of electrical wirings, and the electrical wirings to connect the respective ends of the plurality of electrodes are formed on side faces of the steps.

7. The optical module according to claim 1, wherein the wiring substrate is composed of a plurality of layers connected through through-holes.

8. (canceled)

9. The optical module according to claim 1 having:
an insulating layer provided on the surface of the wiring substrate;
a plurality of electrical wirings formed on the rear face of the wiring substrate; and
one or more through-holes in the circumferential direction in the insulating layer and the wiring substrate correspondingly to the electrical wirings, wherein the respective ends of the plurality of electrodes are connected to the electrical wirings through the through-hole so that the insulating layer is sandwiched between an electrode protruding face of the optical device and the wiring substrate.

10. An optical transmitter-receiver using the optical module according to claim 1 for optical transmitting and receiving.
